(19) United States
(12) Patent Application Publication
(10) Pub. No.: US 2023/0289127 A1
(43) Pub. Date: Sep. 14, 2023

(54) MUTE MANAGEMENT FOR COMMUNICATION APPLICATIONS

(71) Applicant: MICROSOFT TECHNOLOGY LICENSING, LLC, Redmond, WA (US)

(72) Inventors: Ravi GUPTA, Seattle, WA (US); Martin A. MCCLEAN, Seattle, WA (US); Adam Taylor WAYMENT, Renton, WA (US); Tyler WHITE, Seattle, WA (US); Michael Michael AJAX, Redmond, WA (US); Kyle Thomas BRADY, Seattle, WA (US); Srinivas CHAKRAVARTHULA, Kirkland, WA (US); Hanna L. MCLAUGHLIN, Seattle, WA (US); Gabriel S. MARTINEZ, Seattle, WA (US); Mark J. MCNULTY, Renton, WA (US)

(21) Appl. No.: 17/692,519

(22) Filed: Mar. 11, 2022

(51) Int. Cl. G06F 3/16; H04L 65/1089; H04L 65/1096; G06F 3/04817; H04R 29/00

(52) U.S. Cl. CPC G06F 3/165; H04L 65/1089; H04L 65/1096; G06F 3/04817; H04R 29/004

(57) ABSTRACT

System and methods for network communication mute management are provided. In one embodiment, a method for operating system level mute services comprises: registering activation of a first network communication call by a first communication application with an operating system; subscribing the first communication application to operating system level mute services; with the operating system level mute services, monitoring a mute state of the first communication application based on one or more messages from the first communication application, and displaying a mute state indication via a mute user interface; and with the operating system level mute services, monitoring for a mute state change request based on user interaction with the mute user interface, and selectively forwarding the mute state change request to the first communication application.

### BACKGROUND

Voice-over-IP (VoIP) applications, such as voice conferencing applications, running on networked computer systems and workstations are commonly used for communication purposes. For example, video conference platforms are now pervasive, permitting end users to establish voice and/or video communications with each other, utilizing VoIP client applications that run on their desktop or portable computing devices. Furthermore, the display of a computing system may present multiple user interfaces, each associated with a different application concurrently running on the computing system. To allow a user to mute their microphone on a VoIP call, the user interface of the VoIP client application may provide a mute button. Activating the mute button disables communication of the user's microphone input through an audio output channel to the other users on the call. Such a need may arise, for example, when the user needs to avoid broadcasting portions of a local private conversation, or to avoid broadcasting distracting background noise to the other users on the call. That VoIP client application's user interface may also present to the end user a status indication (typically in the form of an icon) to let the user know whether their current call is muted, or not muted.

However, there are problems that interfere with the ability of the computer system to manage the mute state of the audio output channel in accordance with user intentions. For one, VoIP client applications for different video conference platform providers differ in the presentation of their respective user interface layouts, and often differ in the symbology they use for the mute function. These differences may result in user confusion during a call as the user tries to remember which platform they are on to accurately parse the application user interface to find the mute button and understand the current mute status of the call. Another problem occurs when the display presents multiple application user interfaces to the user. The user interface containing the VoIP client application can become at least partially obstructed by one or more overlaying user interfaces of other applications, or become minimized, or otherwise not appear on-screen. In such cases, the user may have an understanding that the call state is either muted or un-muted, but is not provided with any visual feedback from the computer display to confirm if their understanding is correct. This lack of accurate visual feedback from the display can result in the computing system inadvertently transmitting audio to other users that the user did not intend the other users to receive. Conversely, lack of accurate visual feedback can cause the user to incur the embarrassment of speaking to an audience unable to hear them. In either circumstance, the operation of the underlying system is hindering rather that facilitating fruitful communications. Moreover, the overlay of the various interfaces can impede bringing the user interface for the VoIP client application to the front to make the communication application user interface with the mute control accessible for use. This scenario can be particularly frustrating to the user when the other overlaying interfaces contain information that the user wants to keep displayed in the foreground, e.g., for reference during a call.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technology described herein addresses the problem of user devices that fail to present accurate visual indications of mute status for communication applications, or readily accessible user controls for changing the mute state for communication applications. The disclosed technology improves access to the mute function of communication applications (e.g., video conferencing applications) by introducing operating system (OS) level mute services that present a mute control and status interface to the user in a consistent manner and/or non-obstructed location on a display.

The technology described herein enables the operating system to provide a mute control on a portion of the operating system interface that is not typically obstructed by application interfaces. In some examples, the mute-control interface is presented in a task bar or system tray. The mute-control interface provided by the technology described herein is different from a system mute control. A system mute control may shut off an audio input completely for all applications and the operating system itself. In contrast, the technology described herein allows the operating system to control the mute state of a particular function of a particular application, e.g., an outgoing audio channel in a communication session being conducted by a communication application. The audio input (e.g., microphone) may still be used by other applications and even used for other purposes (e.g., other than outputting audio to an active communication session) by the particular application, e.g., the communication application conducting the communication session.

The OS-level mute services may be implemented, at least in part, by an application programming interface (API) service application in the user-device OS that is referred to herein as the Voice Mute Coordinator (VMC). The mute services offered via the VMC are consumed by client communication applications that are configured to integrate with it.

The VMC provides an operating system level mute user interface that is displayed on the display screen of the user device. The VMC monitors for messages from the communication application that provide the mute state of the application's audio output channel. The VMC communicates the current mute state, as reported by the communication application, through the mute user interface. The VMC also monitors for user interaction with the mute user interface. When the user operates the mute control provided by the mute user interface, the VMC sends a message to the communication application to update the current mute state accordingly. The VMC again monitors for a message from the communication application indicating the mute state has changed, and in response updates the mute-status indication. The mute user interface thus displays a status indication that is confirmed as the current mute state by the communication application. The computer system may be running more than one communication application, each with a respective audio output channel under its control. In some embodiments, the mute user interface may therefore further display information indicating the mute state for each of the communication applications.

The OS-level mute services enable communication applications to integrate with the OS more deeply, which enhances the user experience. It enables network communication apps to share their call state and mute state with the OS and register for external mute state toggle requests from the OS. The user may use the mute user interface to mute the microphone for the active application (e.g. the communication application with the active call), but still use the microphone for other purposes such as voice recognition, voice assistants, or a call in another communication application. That is, when the microphone is used by an application that is not a mutable communication application (e.g., an application that does not report a call state), the system treats the microphone usage in a standard manner, allowing the user to continue to use the microphone. Communication applications may continue to use the microphone while muted, for example to (a) adaptively tune echo cancellation algorithms, preventing echo when the user unmutes, and (b) generate notifications that the user is muted if the user accidentally has their microphone muted when they begin talking again.

The mute management solution disclosed herein thus results in a mute UI where mute control and status indications are provided in a consistent manner regardless of which communication application is currently sending voice signals over an audio output channel, and regardless of whether the communication application is operating within an interface that is the current active interface, or within an interface that is covered, minimized, off screen, or otherwise obscured. The solution avoids hidden or ambiguous presentations of mute information on the display of the user device.

### BRIEF DESCRIPTION OF THE DRAWINGS

The technology described herein is illustrated by way of example and not limitation in the accompanying figures in which like reference numerals indicate similar elements and in which:

FIG. 1 is a block diagram of an example operating environment suitable for implementations of the present disclosure;

FIG. 2 is a block diagram of an example computing environment suitable for implementations of the present disclosure;

FIG. 3 is a flow diagram illustrating an example interaction between components that implement OS-level mute services for a communication application;

FIG. 4 is a flow diagram illustrating an example interaction between components that implement OS-level mute services for multiple communication applications;

FIGS. 5A, 5B, 5C and 5D are diagrams illustrating an example embodiment of an operating system's mute user interface;

FIGS. 6A and 6B are example screen displays illustrating an operating system's mute user interface;

FIG. 7 is a flow diagram showing an example method embodiment for mute management by an operating system;

FIG. 8 is a flow diagram showing another example method embodiment for mute management by an operating system;

FIG. 9 is a flow diagram showing yet another example method embodiment for mute management by an operating system; and

FIG. 10 is a block diagram illustrating a computing device suitable for use with aspects of the technology described herein.

### DETAILED DESCRIPTION

The various technologies described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

One or more of the embodiments presented herein address, among other things, the problem of ambiguous display of mute status information and control interfaces by computer systems. More specifically, the technology described herein introduces systems and methods for operating system (OS) level mute services that present a mute control and status interface to the user in a consistent manner and/or non-obstructed location on the display. As discussed previously, a mute control and status interface provided by a communication application can become obscured on the display when the interface containing the communication application is at least partially obstructed by one or more overlaying interfaces of other applications, or minimized, or otherwise not on-screen. The user interface designs of communication applications also vary appreciably from one platform to another, without standard mute control icons or control logic, forcing users to learn the nuances of each different communication application. The OS-level mute services embodiments presented herein facilitates unambiguous presentation of a mute management interface on the display of the user device.

Voice over Internet Protocol (VoIP), which is also referred to as IP telephony, generally refers to a technology for providing voice and/or multimedia (e.g., video) communication sessions over Internet Protocol (IP) networks, such as, but not limited to the Internet. However, the OS-level mute services described herein need not be limited to voice carried over IP networks, or otherwise dependent on the particular underlying network technology used to carry those communications. As such the terms “communication application” and “communication applications” are used herein interchangeably as including and encompassing VoIP applications. IP telephony applications, video conferencing, video game, and/or other applications that carry such communications over IP or non-IP communications networks. It should be understood that a communication application is thus intended to broadly include a range of applications that may be executed on the user device that receive audio input at the user device, such as from an audio input port or audio sensor (such as an internal microphone or externally connected microphone, for example) and transport that audio signal over a network to one or more other user devices via an audio output channel. The communication session, which includes a mutable audio output channel, may be alternatively described herein as a call, voice call, video call, video conference, and the like. The communication session may include other output channels, such as video, texting, and multimedia channels (e.g., screen sharing).

OS-level mute services may be implemented, at least in part, by an application programming interface (API) service application of the user device's OS that is referred to herein as the Voice Mute Coordinator (VMC). The mute services offered via the VMC are consumed by client applications that are configured to integrate with it. The VMC, in turn, communicates with a mute user interface provided by the OS. For example, the OS may display a mute user interface in a taskbar or other region of the OS user interface. The mute user interface presents an application mute control and mute-status indication in a consistent manner regardless of which communication application is currently sending voice signals over an audio output channel. The controls and indication are also provided regardless of whether the communication application is operating within a visible interface or within an interface that is covered, minimized, off screen, or otherwise obscured.

As discussed in detail below, the VMC is notified when a communication application opens an audio output channel over a network connection. The VMC also monitors for messages from the communication application indicating the mute state of the audio output channel. The technology described herein allows the mute state to be controlled at the application level or the OS level. The mute state may be accurately indicated at both the OS level and the application level. When the communication application's mute function is in an inactive state (i.e., not muted), the communication application may send any captured voice signals over the audio output channel. When the communication application's mute function is in an active state (e.g., muted), the communication application may suspend the sending of voice signals over the audio output channel.

The VMC communicates the current mute state, as reported by the communication application, to the mute user interface. The mute user interface then displays the current mute state as a status indication. The VMC also monitors for user interaction with the mute user interface. When the user operates the mute control provided by the OS-level mute user interface, the VMC sends a message to the communication application to update the communication application's mute state accordingly. For example, the user may select a virtual mute control button on the OS-level mute user interface to toggle the mute state from inactive to active, or vice versa. The VMC receives that information from the mute user interface and sends a message the communication application to toggle the mute state, and the communication application responds to that message from the VMC accordingly. The VMC again monitors for a message from the communication application indicating the mute state has changed, and in response updates the mute-status indication on the OS-level mute user interface. In this way, the mute user interface displays a status indication that is based on a confirmation message from the communication application of the current mute state. It should also be noted that at any one time, the computer system may be running more than one communication application, each with a respective audio output channel under its control. Accordingly, in some embodiments, the mute user interface may further display information indicating the mute state for each of the communication applications, and display mute control features that facilitate toggling of the mute state for each of the communication applications.

It should be understood that it is the audio output channel carrying the audio signal that is muted, or unmuted, by the OS-level mute services discussed herein. Activation of the communication application's muting feature does not necessarily inhibit utilization of a captured audio signal for other purposes by the communication application or other applications. For example, the communication application may still locally process the audio information to adaptively tune echo cancellation algorithms, for adaptive background noise cancellation algorithms, for input gain control, and/or to generate user information prompts, such as a warning to inform the user if they are speaking while their audio output is muted. The audio signal also remains available for input for other applications such as, but not limited to, virtual voice assistant services or voice recorders, for example.

It should also be understood that the communication applications that operate in conjunction with the mute services discussed herein might include any application that captures and then retransmits voice signals over a network. As already mentioned, one example communication application is a communication application that operates in conjunction with a video conference platform to provide two-way (e.g., bidirectional) voice and video telecommunications between users over a network. In other example embodiments, the communication application may instead provide two-way audio telecommunications without accompanying video. In still other embodiments, the communication application, rather than providing telecommunications, is used for other voice-operated services that only involve a one-way transmission of voice signals from the user to a network server. Such voice-operated services may comprise cloud-based concierge or shopping services, a virtual assistant (e.g., Cortana, Siri, Alexa), a voice-to-text input interface, or the like. It should also be understood that communication applications may comprise locally executed software applications under the control of the OS, or web applications, applets, or similar code executed within a web browser or other locally executed runtime environment.

Having briefly described an overview of aspects of the technology described herein, an exemplary operating environment in which aspects of the technology described herein may be implemented is described below in order to provide a general context for various aspects.

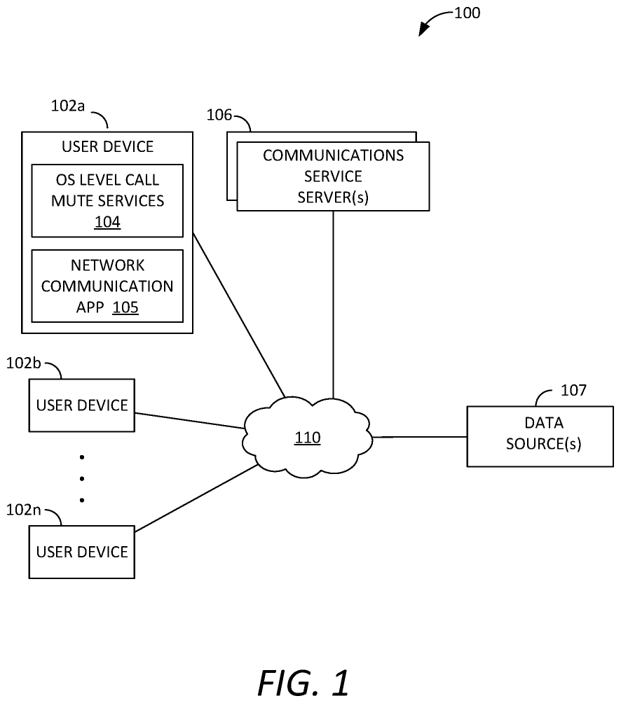

Turning now to FIG. 1, a block diagram is provided showing an example operating environment 100 in which some aspects of the present disclosure may be employed. It should be understood that this and other arrangements described herein are set forth only as examples. Other arrangements and elements (e.g., machines, interfaces, functions, orders, and/or groupings of functions) may be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by at least one processor executing instructions stored in memory.

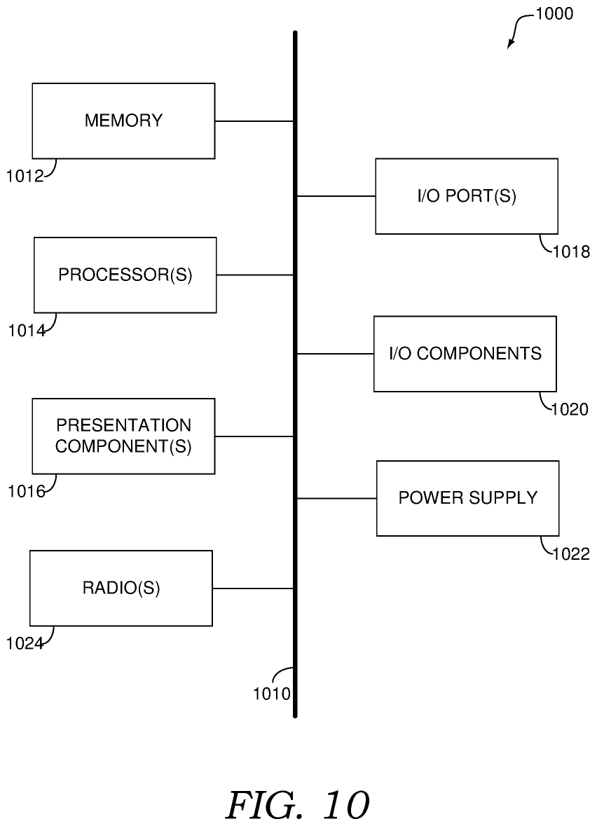

Among other components not shown, example operating environment 100 includes a number of user devices, such as user devices 102a and 102b through 102n; one or more servers 106, one or more data sources 107; and network 110. Each of the components shown in FIG. 1 may be implemented via any type of computing device, such as computing device 1000 described in connection to FIG. 10, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

User devices 102a and 102b through 102n may be client devices on the client-side of operating environment 100, while server(s) 106 may be on the server-side of operating environment 100. Server(s) 106 may comprise server-side software designed to work in conjunction with client-side software on user devices 102a and 102b through 102n to implement any combination of the features and functionalities discussed in the present disclosure. Data sources 107 may comprise data sources and/or data systems, which are configured to make data available to any of the various constituents of operating environment 100.

In aspects, the technology described herein may take the form of OS-level mute services 104 running on any one or more of the user devices. For example, the user device 102a may comprise at least one communication application 105 that captures local audio input and transports the audio inputs over an audio output channel established via network 110 to either a server 106 or data source 107. Such audio output channels may comprise either one-way or bidirectional communications links established over the network 110. For example, the server 106 may comprise a cloud based telecommunications service, such as a videoconference platform or other VoIP service, through which a user of the user device 102a communicates with another user device by voice communications. Example cloud based videoconferencing services include, but are not limited to, Microsoft TEAMS, Microsoft SKYPE, Zoom, GotoMeeting, Citrix Webex, Facebook Messenger, or other videoconferencing or cloud communication platform. In other aspects, the communication application 105 may communicate voice information to a server 106 or other user devices in the context of a gaming application (for example, a gaming server).

The data sources 107 may comprise email servers, social media servers, cloud based concierge or shopping services, virtual assistants, gaming servers, or queryable database, for example. In some embodiments, the communication application 105 establishes an audio output channel via network 110 to one or more of the data sources 107 to send captured audio inputs to interact with the data source 107, such as to send instructions or request information. Data source(s) 107 may be discrete from server(s) 106 or may be incorporated and/or integrated into at least one of those components. In other aspects, the communication application 105 of user device 102a establishes a peer-to-peer audio output channel with another user device via network 110. In each of these various implementations, the OS-level mute services 104 controls the mute state of the audio output channel established by the communication application 105.

This operating environment 100 is provided to illustrate one example of a suitable environment, and there is no requirement for each implementation that any combination of server(s) 106, data source(s) 107 and user devices 102a and 102b through 102n remain as separate entities.

User devices 102a and 102b through 102n may comprise any type of computing device capable of use by a user. For example, in one aspect, user devices 102a through 102n may be the type of computing device described in relation to FIG. 10 herein. By way of example and not limitation, a user device may be embodied as a personal computer (PC), a laptop computer, a mobile device, a smartphone, a tablet computer, a smart watch, a wearable computer, a fitness tracker, a virtual reality headset, augmented reality glasses, a personal digital assistant (PDA), a video player, a handheld communications device, a gaming device or system, an entertainment system, a vehicle computer system, an embedded system controller, a remote control, an appliance, a consumer electronic device, a workstation, or any combination of these delineated devices, or any other suitable device.

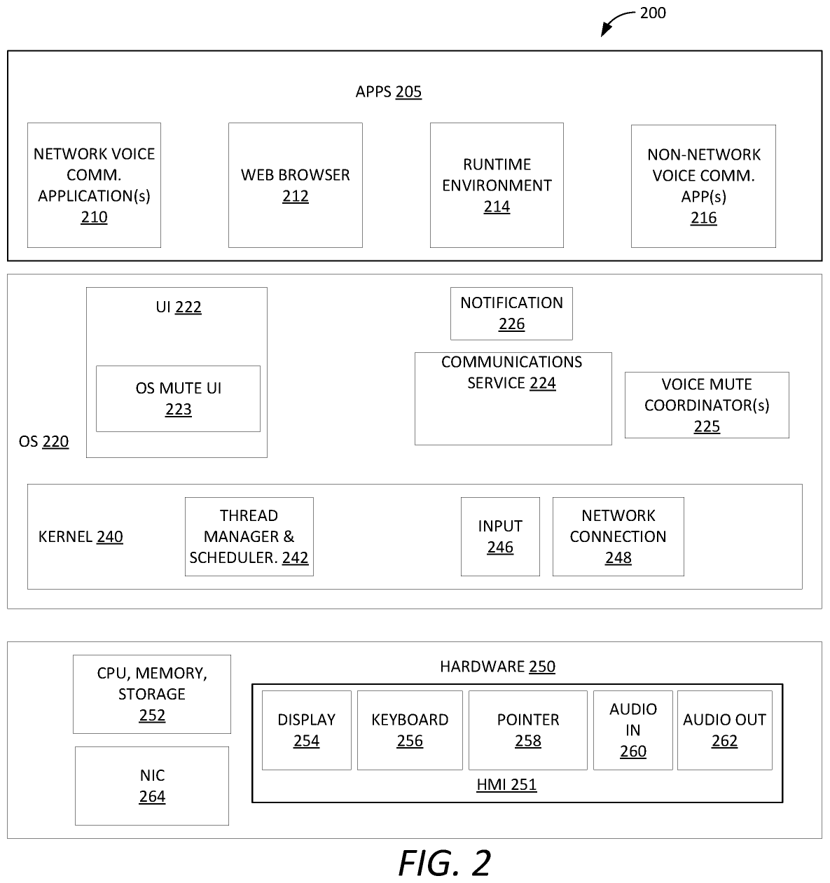

Operating environment 100 may be utilized to implement one or more of the components of a user device system architecture system 200, described in FIG. 2, including components for an OS-level mute services 104 for a user device 102a as illustrated in FIG. 1.

Some components described in FIG. 2 are described using terms often used to describe components of the WINDOWS operating system provided by MICROSOFT. However, aspects of the technology described herein are not limited to use with WINDOWS. The features of the technology described herein may be added to other operating systems, which include many of the same components and perform similar features.

The computing environment 200 comprises a hardware layer 250, operating system components 220 (which include kernel components 240) and example applications 205.

Among other components, the hardware layer 250 comprises one or more central processing units (CPUs), a memory, and storage, collectively illustrated at 252. The hardware layer 250 also comprises one or more elements that together define a human-machine interface (HMI) 251 through which a user interacts with the system 200. The HMI 251 may comprises input/output (I/O) elements such as, but not limited to, a display 254, keyboard 256, pointer device 258, audio input 260 (such as an internal microphone or audio input port), audio output 262 (such as a speaker or audio output port), and/or a network interface controller (NIC) 264. The CPU, memory, and storage 252 may be similar to those described in FIG. 10. The display 254 may comprise any form of computing device display, touch screen, and/or augmented reality or virtual reality device. The pointer device 258 may comprise a mouse, track ball, touch screen, touch pad, natural user input (e.g., gesture) interface or some other input device that controls a location of an interface pointer. The keyboard 256 may be physical keyboard or touchscreen keyboard. The NIC 264 (also known as a network interface card, network adapter, LAN adapter or physical network interface, and by similar terms) is a computer hardware component that connects a computer to a computer network. The NIC 264 allows computers to communicate over a computer network, such as network 110, either by using cables or wirelessly. The NIC 264 may be both a physical layer and data link layer device, as it provides physical access to a networking medium and, for I.E.E.E. 802 standard networks and similar networks, and provides a low-level addressing system through the use of medial access control (MAC) addresses that are uniquely assigned to network interfaces.

Applications 205 (which may also be referred to as user-mode applications) comprise software programs that are loaded into memory for execution by the CPU under the control of the operating system. Non-limiting examples of such applications may include spreadsheets, word processors, browsers, communication applications, and similar user applications. In the particular embodiment shown in FIG. 2, the application include one or more communication applications 210, a web browser 212, a runtime environment 214 (such as a Java, .NET framework, Visual Basic, or other runtime environments, for example), and/or other non-communication applications 216 (such as word processors, spreadsheets, drawing applications, and so forth). As previously discussed, a communication application 210 is an application that communicates captured voice data via an audio output channel over the network 110. The captured voice data may be transmitted via the audio output channel to a server 106 operating telecommunications and/or VoIP services, a data source 107, and/or to other user devices. Conversely, a non-communication application 216 is a software program that does not transmit captured voice data over an audio output channel.

Together with components not shown, the operating system components 220 may be described as an operating system (OS), particularly an OS that implements OS-level mute services 104 as described herein. Some operating systems may combine a user mode and kernel mode or move operations around. In WINDOWS, the processor switches between the two modes depending on what type of code is running on the processor. Applications run in user mode, and core operating system components run in kernel mode. While many drivers run in kernel mode, some drivers may run in user mode.

When a user-mode application 205 starts, the operating system creates a process for the application. The process provides the application with a private virtual address space and a private handle table. Because an application's virtual address space is private, one application cannot alter data that belongs to another application. In addition to being private, the virtual address space of a user-mode application is limited. A processor running in user mode cannot access virtual addresses that are reserved for the operating system. Limiting the virtual address space of a user-mode application prevents the application from viewing, altering, and possibly damaging, critical operating system data.

Kernel components 240 share the same system address space (which is accessible only from kernel-mode). This means that a kernel-mode driver is not isolated from other drivers and the operating system itself.

Many components of the operating system, such as a hardware abstraction layer between the hardware and the kernel components 240, are not shown in FIG. 2. The kernel, of which the kernel components 240 are a part, is a computer program at the core of a computer's operating system and has control over the system. The kernel facilitates interactions between hardware and software components. The kernel controls hardware resources (e.g. I/O, memory) via device drivers, arbitrates conflicts between processes concerning such resources, and optimizes the utilization of common resources (e.g. CPU, memory, and storage 252). On some systems, the kernel is one of the first programs loaded on startup (after the bootloader). Once loaded, the kernel may handle the rest of startup as well as memory, peripherals, and input/output (I/O) requests from software, translating them into data-processing instructions for the CPU.

The code of the kernel may be loaded into a separate area of memory, which is protected from access by applications 205 or other, less critical parts of the operating system. The kernel performs its tasks, such as running processes, managing hardware devices such as the hard disk, and handling interrupts, in this protected kernel space. In contrast, applications 205 may use a separate area of memory, sometimes described as a user mode. This separation helps prevent user data and kernel data from interfering with each other and causing instability and slowness, as well as preventing malfunctioning applications from affecting other applications or crashing the entire operating system.

The kernel components 240, may include, for example, a thread manager and scheduler 242, an input manager 246, and a network connection manager 248. The thread manager and scheduler 242 handles the execution of threads in a process. An instance of a program runs in a process and each process may be assigned an ID that identifies it. A process many have any number of threads depending upon the degree of parallelism desired and each thread has an ID that identifies it. A machine with more than one processor can run multiple threads simultaneously, though multi-threading can also be implemented with a single processor.

The input manager 246 facilitates hardware input from the HMI 251. Device drivers provide the software connection between the devices of the HMI 251 and the operating system. The input manager 246 manages the communication between applications and the interfaces provided by such device drivers. The network connection manager 248 manages communications between the NIC 264, operating system components 220, and applications 205. The network connection manager 248 may provide network context information. The network manager may interact with one or more drivers to implement networking in the operating system.

The operating system components 220 also comprise components that may be considered part of the OS shell, such as user interface (UI) component 222, notification component 226, and communication service component 224. The UI component 222 provides the operating systems main user interface, such as the desktop, and on which applications 205 are presented within an interface. The notification component 226 manages notifications provided through the UI component 222 of the operating system. Notifications may originate from an application 205 or from a service of the OS 220.

In one aspect, the UI 222 and communication service component 224 (and in some implementations the notification component 226) work in conjunction to implement the OS-level mute services 104. For example, the communication service component 224 is a component of the OS 220 that offers video conference and/or voice communication API functions that communication applications 210 call on to facilitate establishing audio output channel instances. The VMC 225 comprises an API of the communication service 224 that may communicate with the communication applications 210 to manage call muting, among other call management functions. VMC 225 also communicates with on operating system mute user interface 223 presented on the display 254 by the UI 222. In some embodiments, the VMC 225 exchanges mute status and control information messages with the mute user interface 223 for OS-level mute services 104 through the notification component 226. In other embodiments, the notification component 226 is not utilized for OS-level mute services 104.

In some embodiments, a communication application 210 may comprise a web application or applet executed within a web browser 212 or runtime environment 214. In such embodiments, the web application or applet would function in the same manner as described herein for a communication application 210 with the understanding that the web browser 212 or runtime environment 214 within which it operates would comprise the functionality (for example, one or more APIs) to pass messages between the web application or applet and the VMC 225.

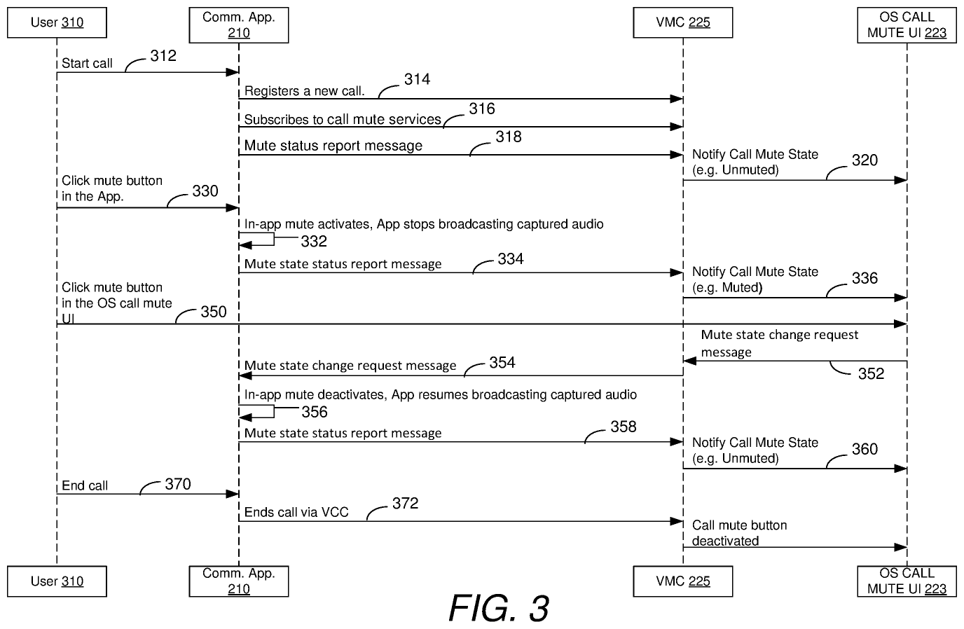

FIG. 3 is a flow diagram 300 illustrating an example interaction between various components that implement OS-level mute services 104. Included in this example are the interactions between the HMI 251 (which displays the mute user interface 223), a communication application 210, and the VMC 225.

The mute user interface 223 is displayed by the HMI 251 on the display 254. The mute user interface 223 includes a mute-status indication. The mute user interface 223 also includes a mute control that the user can interact with, for example, using a pointer device 258 or touch screen feature of the display 254, or using voice commands received at the audio in 260. The mute user interface 223 remains readily accessible to the user regardless of how the application 205 interfaces are otherwise presented on the display 254. In this example, the communication application 210 is running on a desktop/laptop user device. Audio output occurs through a pair of speakers or headphones, and audio input occurs through a microphone input (for example, built-in microphone, a USB microphone or webcam integrated microphone, or similar audio input device).

In this example, the user (shown at 310) interacts with a communication application 210 to start a video call that includes an audio output channel (shown at 312). This interaction may comprise either initiating a new call originated by the user 310 or answer an incoming call originating from another user device. The communication application 210, in response, sends a new call message 314 to the communication service 224, which also serves to register the activation of a communication session (e.g., call) having an audio output channel with the VMC 225. If an instance of the VMC 225 does not yet exist, then the registration also triggers instantiating the VMC 225.

If the communication application 210 is programed to consume the OS-level mute services 104, then it will also send a subscription request message 316 to the VMC 225. In some embodiments, the communication service 224 establishes an instance of the VMC 225 in response to receiving the registration message, which then becomes available to receive the subscription message. In other embodiments, the new call message and subscription request are communicated together. The VMC 225 also receives a mute-status report message 318 from the communication application 210 indicating the current mute state of the audio output channel. Based on the current mute state reported by the communication application 210, the VMC 225 instructs the UI 222 to display the mute UI 223 with an indication of the current mute state (shown at 320).

When the communication application's mute function is in an inactive state (e.g., not muted), the communication application 210 sends any captured voice signals over the audio output channel and the mute UI 223 is updated by VMC 225 to indicate that call muting is not active. When the communication application's mute function is in an active state, the communication application 210 has suspended the sending of voice signals over the audio output channel and the mute UI 223 is updated by VMC 225 to indicate that call muting is not active. The VMC 225 continues to monitor for the reception of mute-state status messages from the communication application 210 and also monitor for the reception of mute state change requests from the mute UI 223.

As shown at 330, when the user 310 interacts with the communication application 210 to toggle the current mute state of the communication application, the communication application 210 will respond by toggling its mute state from active to inactive, or vice versa, and then send a mute state status report message 334 to the VMC 225 to update the mute-status indication on the mute UI 223. For example, at 330, the user 310 clicks a mute button provided directly by the communication application 210. The communication application 210 activates the mute function (shown at 332) and the communication application 210 suspends transmitting captured voice signals over the audio output channel. Communication application 210 sends a mute-state status report message 334 to the VMC 225 notifying the VMC 225 that the call is now muted. The VMC 225 notifies the mute UI 223 (shown at 336) to update the mute-status indication on the mute UI 223 to show that the call is muted.

Alternatively, the user 310 may instead interact with the OS mute UI 223. As shown at 350, for example, the user 310 clicks the mute control provided directly by the OS mute UI 223 to toggle the current mute state. The mute UI 223 sends a mute-state change request message 352 to the VMC 225, and the VMC 225 sends a corresponding mute-state change request message 354 to the communication application 210. The communication application 210 responds at 356 by toggling the mute state from active to inactive, or vice versa, and then sends a mute state status report messages 358 to the VMC 225 to update (shown at 360) the mute-status indication on the mute UI 223. For example, at 350, the user 310 clicks a mute button provided by the mute UI 223 to request un-muting of the call. Mute UI 223 sends an unmute request 352 to the VMC 225 and the VMC 225 sends a corresponding request 354 to the communication application 210. The communication application 210 deactivates the mute function (at 356) resumes transmitting captured voice signals over the audio output channel. Communication application 210 sends the mute-state status report message 358 to the VMC 225 notifying the VMC 225 that the call is now unmuted. The VMC 225 updates the mute-status indication on the mute UI 223 (shown at 360) to show that the call is unmuted. When the user 310 ends the call (shown at 370), the communication application 210 notifies the VMC 225 (shown at 372). The mute UI 223 is deactivated and/or removed from display 254 (shown at 374).

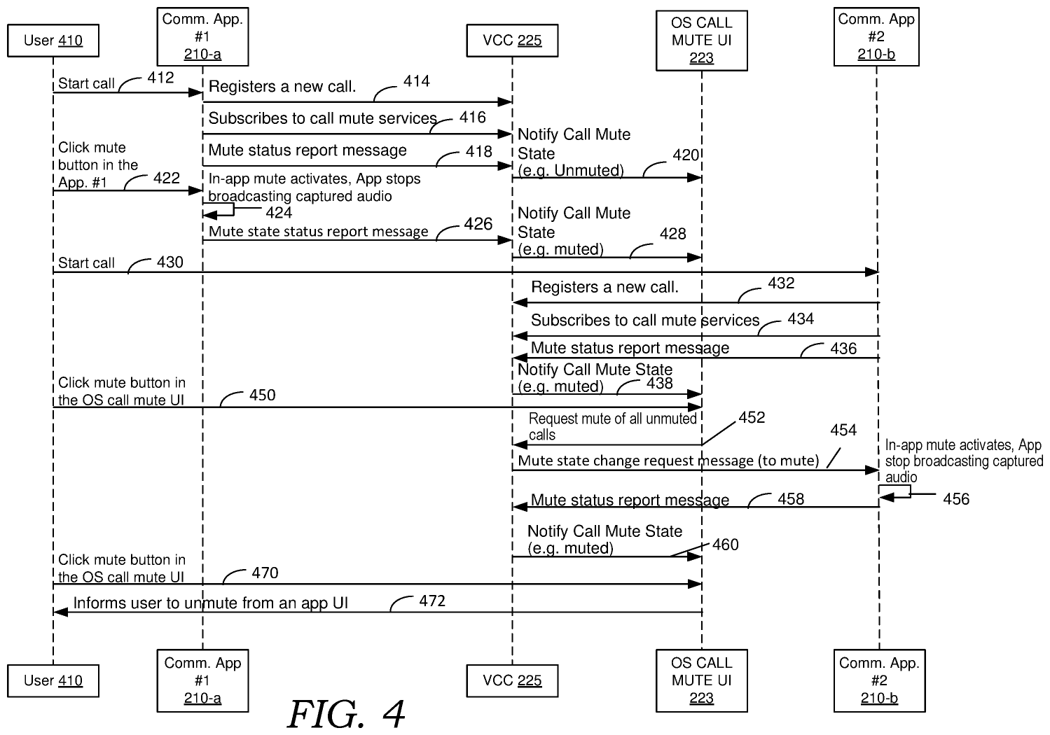

FIG. 4 is a flow diagram 400 illustrating an example interaction between components that implement the OS-level mute services 104 when more than one network communication call (e.g., communication session) is concurrently established. In this example, both a first communication application (shown at 210-a) and a second communication application (210-b) are being utilized by the user 410, and both communication applications register with the OS-level mute services 104. In this example, the function of the mute UI 223 is slightly different as compared to the single communication application case. In this example scenario, the mute UI 223 may either indicate when both calls are muted or alternately indicate when one or more calls are unmuted. If one or more calls are unmuted, when the user 410 presses the mute UI 223 mute state control, then any unmuted calls will be changed to muted. Such an implementation might be applicable to the case where the communication service 224 is not configured to permit more than one communication application to access the microphone concurrently.

Referring to the example of FIG. 4, the user (shown at 410) interacts with a communication application 210-a to start a call over an audio output channel (shown at 412). This interaction may comprise either initiating a new call originated by the user 410 or answering an incoming call originating from another user device. The communication application 210-a, in response, sends a new call message 414 to the communication service 224, which also serves to register the activation of an audio output channel with the VMC 225. If an instance of the VMC 225 does not yet exist, then the registration also triggers instantiating the VMC 225. If the communication application 210-a is programed to consume the OS-level mute services 104, then it will also send a subscription request message 416 to the VMC 225. The VMC 225 also receives a mute status report message 418 from the communication application 210-a indicating the current mute state of that application's audio output channel. Based on the current mute state reported by the communication application 210-a, the VMC 225 instructs the UI 222 to display the mute UI 223 with an indication of the current mute state (shown at 420).

In the example of FIG. 4, the initial mute state for communication application 210-a is unmuted, so the VMC 225 reports the unmute current call state to the mute UI 223 for display. If the user 410 activates the mute control via the communication application 210-a (shown at 422), the communication application 210-a responds by muting its audio output channel (shown at 424) and reports the current mute state to the VMC 225. The VMC 225 instructs the mute UI 223 to change its mute state status indication from unmuted to muted.

Now the user 410 interacts with a second communication application 210-b to start a second call over a second audio output channel (shown at 430). This interaction may comprise either initiating a new call originated by the user 410 or answering an incoming call originating from another user device. The communication application 210-b, in response, sends a new call message 432 to the communication service 224, which also serves to register the activation of the second audio output channel with the VMC 225. If the communication application 210-b is programed to consume the OS-level mute services 104, then it will send a subscription request message 434 to the VMC 225. The VMC 225 also receives a mute status report message 436 from the communication application 210-b indicating the current mute state of that application's audio output channel. Based on the current mute state reported by the communication application 210-b, the VMC 225 forwards the current mute state to the mute UI 223.

If either the communication application 210-a or the communication application 210-b are unmuted, then the mute UI 223 will indicate that at least one call is not muted. If both the communication application 210-a and the communication application 210-b are muted, then the mute UI 223 will indicate that all calls are muted.

When the user 410 now interacts with the mute control of the mute UI 223 (shown at 450), it reports a mute state change request to the VMC 225 (shown at 452). Because two communication applications are registered, the VMC 225 responds by sending a mute state request to any communication application that currently is unmuted. In this example, the VMC 225 sends a mute state request 454 to the second communication application 210-b to mute. The second communication application 210-b, in response, activates muting on its audio output channel (shown at 456) and sends a mute state status report 458 back to the VMC 225 confirming that its audio output channel is muted. Upon receiving that confirmation, the VMC 225 notifies the mute UI 223 (shown at 460) will indicate that all calls are muted. In some embodiments, with both calls now muted, should the user 410 activate the mute control of the mute UI 223 (shown at 470), the VMC 225 will instruct the UI 222 to display a message to the user 410 to use the mute controls provided by the communication application(s) to unmute an audio output channel.

In other embodiments, should the user 410 activate the mute control of the mute UI 223 with all calls muted 223, the mute UI 223 may display a menu that allows the user 410 to select which of the communication applications to unmute. For example, a menu may be presented that displays options to unmute communication application 210-a, unmute communication app 210-b, or unmute all. Once either the first or second communication application call is terminated, then single communication application operation of the OS-level mute services 104 as described in FIG. 3 will resume.

Other implementations to manage mute status when more than one network communication call is concurrently established may also be employed. For example, in one alternate embodiment, the OS-level mute services 104 accommodates concurrent calls by the underlying communication service 224 by brokering hold states across communication applications. For example, in one scenario, the user 410 has an active call on communication application 102-a and then starts a new call (or accepts an incoming call) in communication application 102-b without first ending the call on communication application 102-a. When communication application 102-b starts its call, the communication service 224 issues a “Hold” command to communication application 102-a. Internally, communication application 102-a responds to the Hold command by placing its call into a Hold state. At this point, there are two calls registered with the VMC 225, but only the call from communication application 102-b is “Active”. This ensures that only one call is active at a time, and that the mute control appearing on the mute UI 223 works as expected—without the risk of accidentally toggling the mute state of the second call. That is, the mute UI 223 operates as described in FIG. 3 for the “Active” communication application, and neither displays mute state status or permits mute state toggling for the communication application on Hold. When a call is on Hold, the user may resume the call from within the desired communication application. This action results in the communication application resuming the call and reporting the state change to become active to the communication service 224. When this occurs, the communication service 224 issues a Hold command to the previously active communication application and the mute UI 223 then operates as described in FIG. 3 for the newly activated communication application, and not the communication application newly placed on Hold.

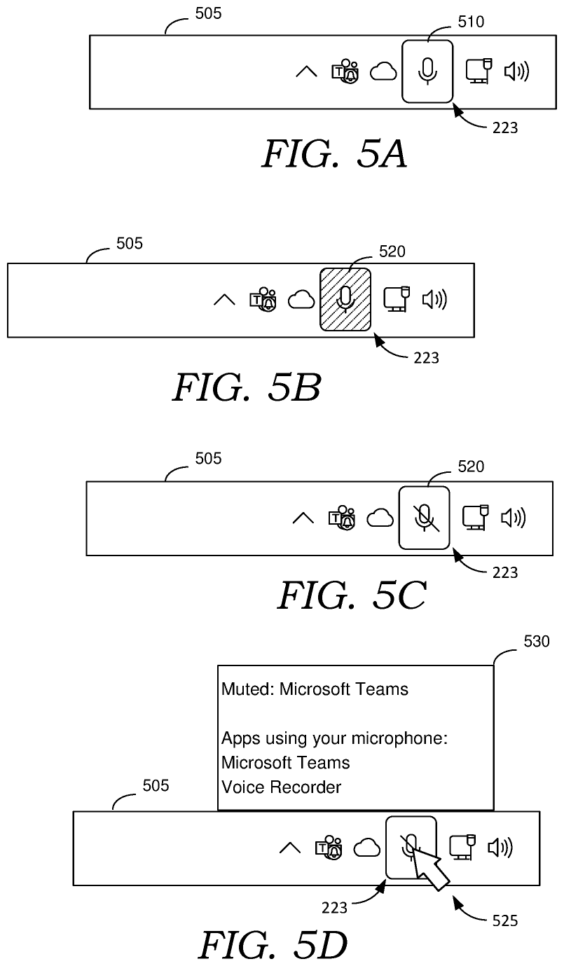

FIGS. 5A, 5B, 5C and 5D illustrate an example mute UI 223 implementation. In this example, the mute UI 223 is implemented using a symbol 510, in this case comprising a microphone icon 510, located within and defining an element of an OS taskbar 505. It should be noted that the microphone icon 510 is used for illustration purposes only, and in other embodiments, other symbols or text may be used in place of or in addition to a microphone icon for the mute UI 223. In this example, the symbol 510 functions as both the mute control and the mute-status indication. However, in other embodiments the mute control and the mute-status indication can be realized by the mute UI 223 using separate distinct icons for each respective function. Referring first to FIG. 5A, the symbol 510 is not a button or other interactive element of the taskbar. This indicates that a communication application is accessing a microphone to capture audio (e.g. voice), but that the communication application has not subscribed with the VMC 225 to access the OS-level mute services 104. That is, without regard to why an application is accessing the microphone, the symbol 510 merely reflects the fact that is it being used by an application. In some embodiments, when the user hovers a pointer over the inactive symbol 510, the system may display which application is using the microphone.

Referring to FIG. 5B, once a communication application has subscribed to the OS-level mute services 104 with the VMC 225, the VMC 225 changes the symbol 510 to now display an interactive element 520 (e.g., a button) that provides for mute state control and also indicates the current mute state reported by the communication application to the VMC 225. For example, a user clicking on the button 520 will cause the VMC 225 to send a mute state change request into the communication application. The communication application will handle the request and then report the updated current mute state back to the VMC 225, which then updates the appearance of the button 520 to reflect the current mute state reported by the communication application. In the example of FIG. 5B, the button 520 comprises a microphone icon over a highlighted background indicating that the network communication call is unmuted. FIG. 5C shows the corresponding example where the button 520 comprises a slashed microphone icon over a non-highlighted background indicating that the network communication call is muted. In some embodiments, when the user hovers a pointer 525 over the button 520, the system may display which applications are using the microphone and whether the network communication call is muted or not muted, as shown in FIG. 5D. Also as illustrated in FIG. 5D, an indicated active mute state does not imply that no application is using the microphone. Here the communication service displays a notice 530 reporting that the Voice Recorder is as actively recording even though the communication application (Microsoft Teams in this example) call is muted.

Although FIGS. 5A-5D illustrate the mute UI 223 implemented as an element of an OS taskbar, it should be understood that in other embodiments the mute UI 223 can be implemented in other ways. For example, the mute UI 223 can otherwise be implemented within other OS managed resources such as a system tray, dock, icon bar, menu bar, notification center, or panel. Regardless of the implementation, the mute UI 223 displayed mute state is linked to the mute state reported by the communication application. This means that when the user clicks on the interactive element 520 to toggle mute state, clicking on it will not directly change the displayed mute state. Instead, the VMC 225 will dispatch the mute state change request message to the communication application, and then once the communication application changes the mute state, the appearance of the interactive element 520 will update accordingly. As previously explained herein, in some embodiments, when multiple communication applications have subscribed to the OS-level mute services 104, the interactive element 520 of the mute UI 223 will indicate that the mute is active when all communication applications report that their respective calls are muted (i.e., a logic AND), and will indicate that mute function is inactive active when any of the communication applications report that their respective calls are not muted (i.e., a logic OR).

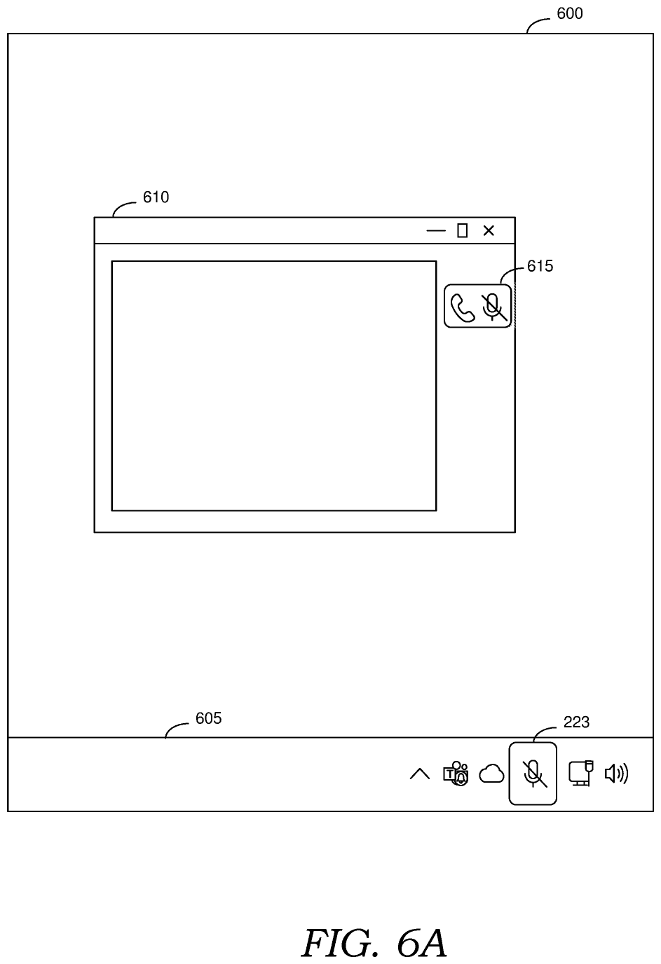

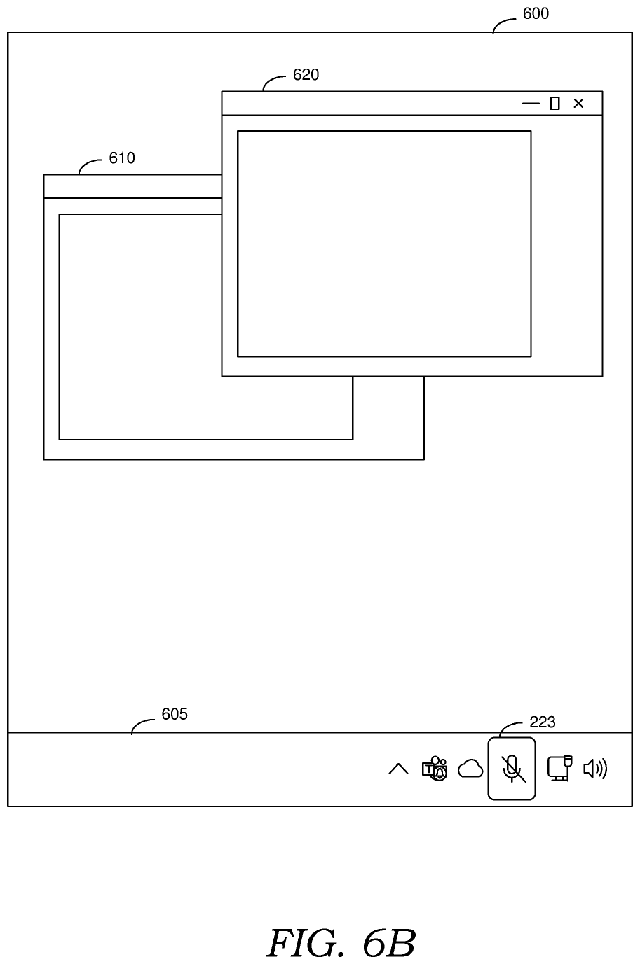

FIG. 6A is an example screenshot 600 that may be provided by display 254, for example. The screenshot 600 includes at least one user interface 610 within which a communication application 210 is executing. The screen also includes the mute UI 223 presented within the context of an OS taskbar 605. As shown in FIG. 6A, the mute status indicated by the mute UI 223 is consistent with the mute status indicator at 615 displayed within the user interface 610 by the communication application 210. However, in FIG. 6B, another user interface 620 is now open and active, and is overlaying the user interface 610 of the communication application 210 such that the mute status indicator 615 is no longer able to provide information to the user, and no longer able to be used to toggle the mute state of communication application 210 as long as it remains covered. However, the mute UI 223 still remains available via the OS taskbar 605 to eliminate the ambiguity caused by the hidden mute status indicator 615. It should be noted that in some implementations, the OS taskbar 605 with the mute UI 223 is always displayed in the same (sometimes user selectable) position on the screen 600. Moreover, even when users elect to “unlock” the OS taskbar 605 so that it remains off-screen until the user moves the pointer to activate it, the solutions presented herein remain effective because taskbar remains readily available without the need to rearrange any of the user application user interfaces to access the mute UI 223.

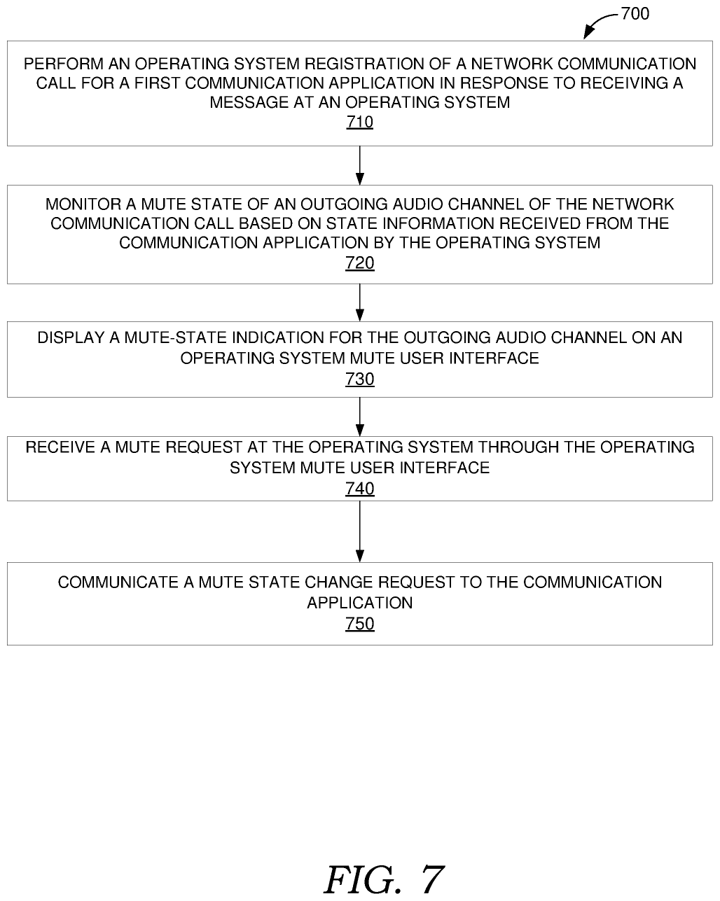

FIGS. 7, 8 and 9 are a flow diagrams showing methods 700, 800 and 900 for managing the mute state of outgoing network audio channels. Each block of the methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by an operating system. In addition, methods 700, 800 and 900 are described, by way of example, with respect to the other embodiments presented in the other figures herein. However, these methods may additionally or alternatively be executed by any one system, or any combination of systems, including, but not limited to, those described herein. It should therefore be understood that the features and elements described herein with respect to the methods of FIGS. 7, 8 and 9 may be used in conjunction with, in combination with, or substituted for elements of, any of the other embodiments discussed herein and vice versa. Further, it should be understood that the functions, structures, and other descriptions of elements for embodiments described in FIGS. 7, 8 and 9 may apply to like or similarly named or described elements across any of the figures and/or embodiments described herein and vice versa.

Referring now to FIG. 7, method 700 includes at 710 performing an operating system registration of a network communication call for a first communication application, in response to receiving a message at the operating system. In some embodiments, the communication application registers with a communication service component 224 of the OS 220 that offers communication API functions that communication applications 210 call on to facilitate establishing network communication audio output channel instances. As previously discussed, a communication application 210 is an application that communicates captured voice data via an audio output channel over the network 110. The captured voice data may be transmitted via the audio output channel to a server 106 operating telecommunications and/or VoIP services, a data source 107, and/or to other user devices. It should also be understood that communication application may comprise locally executed software applications under the control of the OS, or web applications, applets, or similar code executed within a web browser or other locally executed runtime environment. In some embodiments, the communication application subscribes to the OS-level mute services via a voice mute coordinator (such as VMC 225), which may comprise an API service application in the user device's OS.

Method 700 includes at 720 monitoring a mute state of an outgoing audio channel of the network communication call based on state information received from the communication application by the operating system, and at step 730 displaying a mute-state indication for the outgoing audio channel on an operating system mute user interface. For example, the VMC 225 may receive mute state status messages from the communication application and convey that mute state status to the mute UI. In the case where only a single communication application is active (such as in FIG. 3) the mute UI will graphically indicate the mute state reported by the single communication application. In the case where more than one communication application is registered and subscribed, the mute UI may indicate a mute state associated with the “active” communication application, or alternatively apply a logic to display a muted state when all communication applications are muted and an unmuted state when any communication application is unmuted.

Method 700 also includes at 740 receiving a mute request at the operating system through the operating system mute user interface and at step 750 selectively communicating the mute state change request to the communication application. For example, the VMC 225 may receive mute state change requests in response to user interactions from the mute UI, and convey those to the one or more communication applications. In the case where only a single communication application is active (such as in FIG. 3) the VMC will forward the mute state change requests to the single communication application, and then return to 730 to send the mute state update to the mute UI once confirmation is received from the communication application. In the case where more than one communication application is registered and subscribed, the VMC 225 may respond to the mute state change request by forwarding instructions to all unmuted communication applications to activate call muting. Where all communication applications are already muted, the VMC 225 may respond to the mute state change request by instructing the UI 222 to display a message to the user to use mute controls provided by the communication applications to unmute an audio output channel.

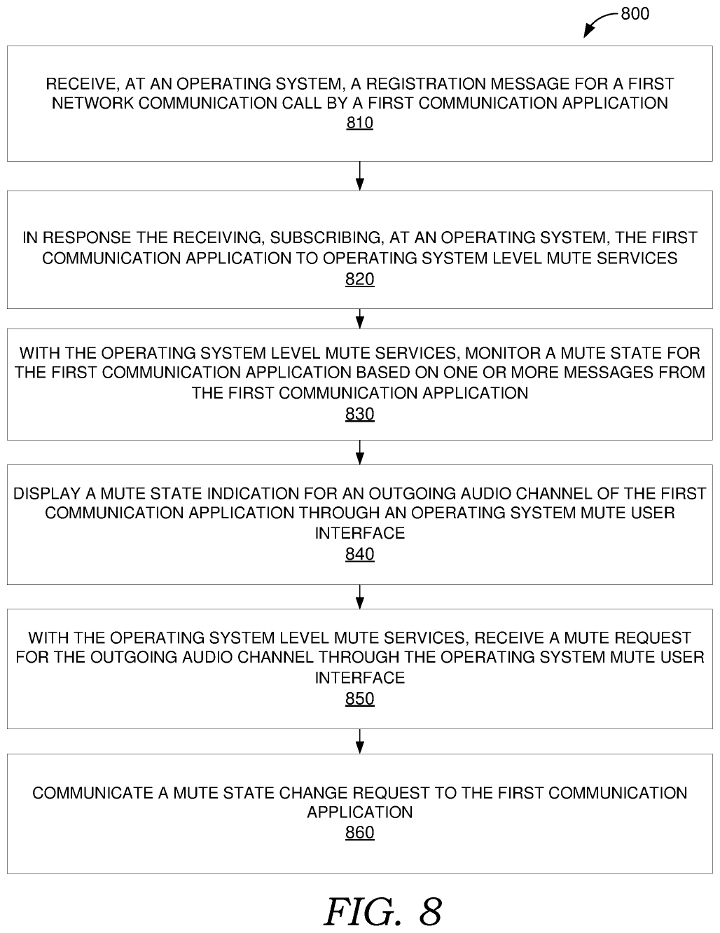

Referring to FIG. 8, the method 800 at 810 includes receiving, at an operating system, a registration message for a first network communication call by a first communication application. At step 820 the method includes, in response the receiving, subscribing, at an operating system, the first communication application to operating system level mute services. In some embodiments, a communication service component 224 of the OS 220 offers communication API functions that communication applications 210 call on to facilitate establishing network communication call instances. OS 220 may registers activation of the first network communication call in response to an instruction from the first communication application received via the communication service component 224. In some embodiments, the communication application subscribes to the OS level call mute services via a voice mute coordinator (such as VMC 225), which may comprise an API service application in the OS 220. For example, the OS 220 may subscribe the communication application to the OS level call mute services in response to receiving an indication from the communication application that it supports interactions with the OS level call mute services.

The communication application is configured to access the communication service to establish an audio output channel over a network, and transmits over the audio output channel voice information captured from an audio input. The audio input data may include, for example voice data, and is transmitted through the audio output channel to a server and/or to other user device(s). In some embodiments, the network audio output channel is a bidirectional channel through which the audio can be transmitted and received by the communication application. In some embodiments, the audio output channel may be used in the implementation of a video conference session comprising bidirectional communication of audio and/or video feeds.

At 830, the method includes the voice mute coordinator, with the operating-system level mute services, monitoring a mute state for the first communication application based on one or more messages from the first communication application. Monitoring of the mute state of the audio output channel may be performed by the voice mute coordinator by utilizing mute state status messages received from the communication application. Based on the mute state of the audio output channel as indicated by those status messages, the voice mute coordinator responds by sending instructions to the mute UI to display a mute state indication. The mute state indication displayed may vary, as discussed above, depending on the number of communication applications that current have established audio output channels.

At 840, the method 800 includes displaying a mute state indication for an outgoing audio channel of the first communication application through an operating system mute user interface. And at 850, the method includes, with the operating system level mute services, receiving a mute request for the outgoing audio channel through the operating system mute user interface. At 860, the method 800 includes communicating a mute state change request to the first communication application. The voice mute coordinator selectively forwards the mute state change requests to the at least one communication application. That is, depending on the number of communication applications that currently have established audio output channels, the voice mute coordinator may respond to the mute state change requests differently. When just one communication application has an established audio output channel, the mute state change request may be directly forwarded to that communication application. When more than one communication application has an established audio output channel, the voice mute coordinator may respond by sending a mute state request to any communication application with an unmuted audio output channel (in the case of a mute request), or instead direct the user to the individual communication application user interfaces (in the case of an unmute request). The method may also accommodates concurrent calls by brokering hold states across communication applications as discussed in more detail herein.

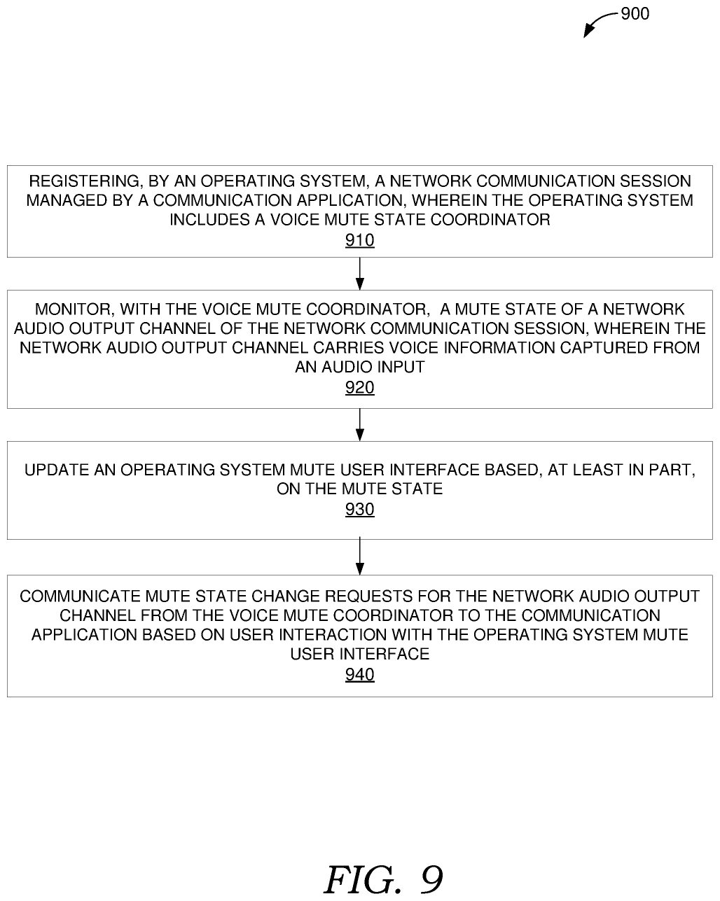

Referring now to FIG. 9, method 900 at 910 includes, registering, by an operating system, a network communication session managed by a communication application, wherein the operating system includes a voice mute state coordinator. The operating system communication service comprises a voice mute coordinator, and the communication application transmits voice information over a network audio output channel, where the voice information is captured from an audio input. The voice information may be transmitted through the network audio output channel to a server and/or to other user devices. In some embodiments, the network audio output channel is a bidirectional channel through which the voice information can be transmitted and received by the communication application. In some embodiments, the audio output channel may be used in the implementation of a video conference session comprising bidirectional communication of audio and/or video feeds.

At 920, the method 900 includes monitoring, with the voice mute coordinator, a mute state of a network audio output channel of the network communication session, wherein the network audio output channel carries voice information captured from an audio input monitoring a mute state of the audio output channel with the voice mute coordinator. The voice mute coordinator updates an operating system's mute user interface based at least in part on the mute state. Monitoring of the mute state of the audio output channel may be performed by the voice mute coordinator by utilizing mute state status messages received from the communication application. Based on the mute state of the audio output channel as indicated by those status messages, the voice mute coordinator responds by sending instructions to the mute UI to display a mute state indication. The mute state indication displayed may vary, as discussed above, depending on the number of communication applications that current have established audio output channels. At 920, the method 900 includes updating the mute user interface based, at least, on the mute state.

At 930, the method 900 includes communicating mute state change requests for the network audio output channel from the voice mute coordinator to the communication application based on user interaction with the mute user interface. In the same manner as discussed above, depending on the number of communication applications that current have established audio output channels, the voice mute coordinator may differ in how it responds to the mute state change requests by either sending a mute state request to any communication application with an unmuted audio output channel (in the case of a mute request), or instead direct the user to the individual communication application user interfaces (in the case of an unmute request). The method may also accommodates concurrent calls by brokering hold states across communication applications as discussed in more detail herein.

The network communication mute management provided by any of the methods 700, 800 or 800 result in a mute UI where the mute control and status indications are provided in a consistent manner regardless of which communication application is currently sending voice signals over an audio output channel, and regardless of whether the communication application is operating within an interface that is the current active interface, or within an interface that is covered, minimized, off screen, or otherwise obscured. The solution avoids hidden or ambiguous presentations of a mute management information on the display of the user device.

Exemplary Operating Environment

Referring to the drawings in general, and initially to FIG. 10 in particular, an exemplary operating environment implementing aspects of the technology described herein is shown and designated generally as computing device 1000. Computing device 1000 is but one example of a suitable computing environment to implement a user device 102a comprising OS-level mute services 104, and is not intended to suggest any limitation as to the scope of use of the technology described herein. Neither should the computing device 1000 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, or similar computing devices. Aspects of the technology described herein may also be practiced in distributed computing environments where tasks are performed by remote-processing devices that are linked through a communications network.

With continued reference to FIG. 10, computing device 1000 includes a bus 1010 that directly or indirectly couples the following devices: memory 1012, one or more processors 1014, one or more presentation components 1016, input/output (I/O) ports 1018, I/O components 1022, and an illustrative power supply 1022. Bus 1010 represents what may be one or more busses (such as an address bus, data bus, or a combination thereof). Although the various blocks of FIG. 10 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 10 is merely illustrative of an exemplary computing device that may be used in connection with one or more aspects of the technology described herein. Distinction is not made between such categories as “workstation,” “server,” “laptop,” “handheld device,” or similar terms, as all are contemplated within the scope of FIG. 10 and refer to “computer” or “computing device.”

Computing device 1000 typically includes a variety of computer-readable media. Computer-readable media may be any available media that may be accessed by computing device 1000 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1012 includes computer storage media in the form of volatile and/or nonvolatile memory. The memory 1012 may be removable, non-removable, or a combination thereof. Exemplary memory includes solid-state memory, hard drives, optical-disc drives, or similar hardware devices. Computing device 1000 includes one or more processors 1014 that read data from various entities such as bus 1010, memory 1012, or I/O components 1022. Presentation component(s) 1016 present data indications to a user or other device. Exemplary presentation components 1016 include a display device, speaker, printing component, vibrating component, or similar audio output device. I/O ports 1018 allow computing device 1000 to be logically coupled to other devices, including I/O components 1022, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 1014 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein. In various different embodiments, any of such I/O components may be included in a user device and utilized by a user to interact with the mute UI 223.

An NUI processes air gestures, voice, or other physiological inputs generated by a user. Appropriate NUI inputs may be interpreted as ink strokes for presentation in association with the computing device 1000. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 1000. The computing device 1000 may be equipped with depth cameras, such as stereoscopic camera systems, infrared camera systems, RGB camera systems, and combinations of these, for gesture detection and recognition. Additionally, the computing device 1000 may be equipped with accelerometers or gyroscopes that enable detection of motion. The output of the accelerometers or gyroscopes may be provided to the display of the computing device 1000 to render immersive augmented reality or virtual reality.

A computing device may include a radio 1024. The radio 1024 transmits and receives radio communications. The computing device may be a wireless terminal adapted to receive communications and media over various wireless networks. Computing device 1000 may communicate via wireless policies, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 policies.

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

1. A system comprising:
one or more processors coupled to a memory;
an operating system executing on the one or more processors, the operating system comprising code to implement a voice mute coordinator and to output a mute user interface, wherein the operating system registers a network communication session managed by a communication application to the voice mute coordinator, wherein the voice mute coordinator:
monitors a mute state of an outgoing audio channel of the communication application based on state information provided to the voice mute coordinator by the communication application;
displays a mute-state indication for the outgoing audio channel on the mute user interface;
receives a mute request through the mute user interface; and
communicates a mute state change requests to the communication application in response to the mute request through the mute user interface.

2. The system of claim 1, wherein the mute user interface is an element of an operating system taskbar, a system tray, a dock, an icon bar, a menu bar, a notification center, or a panel.

3. The system of claim 1, wherein the mute-state indication comprises a symbol or icon that changes appearance based in response to a change in the mute state.

4. The system of claim 3, wherein the symbol or icon displayed by the mute user interface comprises an interactive mute control.

5. The system of claim 1, wherein the communication application comprises a web application executing within a browser or an applet executing within a runtime environment.

6. The system of claim 1, wherein the outgoing audio channel receives audio input from a microphone; and
wherein the operating system displays active applications receiving input from the microphone, and a mute status of each of the active applications.

7. The system of claim 1, wherein the communication application and a second communication application are running on the system and wherein the voice mute coordinator forwards mute state change requests to the communication application or the second communication application based on the mute state of the communication application and the mute state the second communication application.

8. The system of claim 1, wherein the communication application and a second communication application are running on the system and wherein the mute-state indication displays the mute state for the communication application and a second mute state for the second communication application.

9. The system of claim 1, wherein the communication application and a second communication application are running on the system and wherein the voice mute coordinator issues a hold command to mute the outgoing audio channel of the communication application when the second communication application becomes an active application.

10. A method for network communication mute management, the method comprising:
receiving, at an operating system, a registration message for a first network communication call by a first communication application;
in response to the receiving, subscribing, at an operating system, the first communication application to operating system level mute services;
with the operating system level mute services:
monitoring a mute state for the first communication application based on one or more messages to the voice mute coordinator from the first communication application;
displaying a mute state indication for an outgoing audio channel of the first communication application through an operating system mute user interface;
receiving a mute request for the outgoing audio channel through the operating system mute user interface; and
communicating a mute state change request to the first communication application in response to the mute request through the mute user interface.

11. The method of claim 10, wherein the operating system comprises communication application programming interface (API) functions that the first communication application uses to facilitate establishing a network communication audio output channel over a network.

12. The method of claim 10, wherein the first communication application subscribes to the operating system level mute services via a voice mute coordinator (VMC), wherein the VMC comprises an application programming interface (API) service application in the operating system.

13. The method of claim 10, further comprising updating an appearance of a symbol displayed by the mute user interface based on changes to the mute state of the first communication application.

14. The method of claim 10, wherein a mute-state indication of the mute user interface comprises a symbol or icon that changes appearance when the mute state changes.

15. The method of claim 10, wherein the first communication application transmits voice information captured from an audio input over the outgoing audio channel.

16. The method of claim 10, further comprising:
registering activation of a second network communication call by a second communication application with the operating system;
subscribing the second communication application to the operating system level mute services;
with the operating system level mute services, monitoring the mute state of the second communication application based on one or more messages from the second communication application; and
wherein the mute state indication displayed on the mute user interface is based on the mute state of the first communication application and the mute state of the second communication application.

17. The method of claim 16, wherein the mute user interface identifies the first communication application and the second communication application.

18. One or more computer storage media comprising computer-executable instructions that when executed by a computing device cause the computing device to perform a method of network communication mute management, the method comprising:
registering, by an operating system, a network communication session managed by a communication application, wherein the operating system includes a voice mute state coordinator;
with the voice mute state coordinator of the operating system:
monitoring a mute state of a network audio output channel of the network communication session, wherein the network audio output channel carries voice information captured from an audio input;
updating a mute user interface based, at least in part, on the mute state; and
communicating mute state change requests for the network audio output channel from the voice mute coordinator to the communication application based on user interaction with the mute user interface.

19. The media of claim 18, wherein a mute state indication of the mute user interface comprises a symbol or icon that changes appearance when the mute state changes.

20. The media of claim 18, wherein the audio input comprises a microphone; and
wherein the operating system displays active applications receiving input from the microphone and a mute status of the communication application, in response to the user interaction with the mute user interface.
